(19) United States
(12) Patent Application Publication
(10) Pub. No.: US 2007/0085315 A1
(43) Pub. Date: Apr. 19, 2007

(54) Gas bag module for a vehicle occupant restraint system

(75) Inventors: Stefan Hepp, Glattbach (DE); Manfred Berninger, Leidersbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/410,355

(22) Filed: Apr. 25, 2006

(30) Foreign Application Priority Data
Oct. 18, 2005 (DE) 20 2005 016 279.5

(51) Int. Cl. B60R 21/237; B60R 21/23

(52) U.S. Cl. 280/743.1; 280/728.2; 280/743.2

(57) ABSTRACT

A gas bag module for a vehicle occupant restraint system includes a mounting (10) which has an outlet opening (18) closed by a cover (16). The gas bag module further comprises a gas bag (14) accommodated in the mounting (10), which unfolds from a folded state out of the outlet opening (18) when the gas bag module (12) is activated. In the folded state the gas bag (14) is folded in a mushroom-like manner. A non-folded section (20) of the gas bag (14) is delimited by a constriction (22) and lies directly opposite the cover (16).

### TECHNICAL FIELD

The invention relates to a gas bag module for a vehicle occupant restraint system.

### BACKGROUND OF THE INVENTION

It has been proven that the folding of a gas bag housed in a mounting of a gasbag module influences the unfolding behaviour of the gas bag to a considerable extent. Both ordered and disordered gas bag folding techniques are known. For cost reasons, an ability for at least one of the necessary folding steps to be automated is desirable.

It is an object of the invention to provide a gas bag module with a gas bag which can largely be folded by machines and shows an optimized unfolding behaviour.

### BRIEF SUMMARY OF THE INVENTION

According to the invention, a gas bag module comprises a mounting which has an outlet opening closed by a cover. The gas bag module further comprises a gas bag accommodated in the mounting, which unfolds from a folded state out of the outlet opening when the gas bag module is activated. In the folded state the gas bag is folded in a mushroom-like manner. A non-folded section of the gas bag is delimited by a constriction and lies directly opposite the cover. The folding of the gas bag in the manner of a mushroom has the advantage that a smooth section closes off the gas bag package towards the cover, resulting in a better and more readily reproducible opening of the cover when the gas bag unfolds.

The non-folded section is preferably a section which faces the occupant in the unfolded state of the gas bag. In this case, a central (symmetrical) unfolding is achieved with respect to the main direction of unfolding.

The dimension of the non-folded section can be selected to be so great that it corresponds approximately to the dimension of the outlet opening of the mounting.

In a gas bag which has at least one tether, it is advantageous for the unfolding behaviour if the gas bag is arranged in the mounting so that the limiting strap is fastened to the section which is not folded.

A facilitating as regards monitoring whether the gas bag module is equipped with the correct gas bag is achieved in that the gas bag carries a marking which is arranged on the non-folded section.

### BRIEF DESCRIPTION OF THE DRAWINGS

FIG. 1 shows a diagrammatic sectional view through a mounting of a gas bag module according to the invention, with gas bag; and

FIG. 2 shows a perspective view of a gas bag module according to the invention, without a cover.

### DETAILED DESCRIPTION OF THE PREFERRED EMBODIMENT

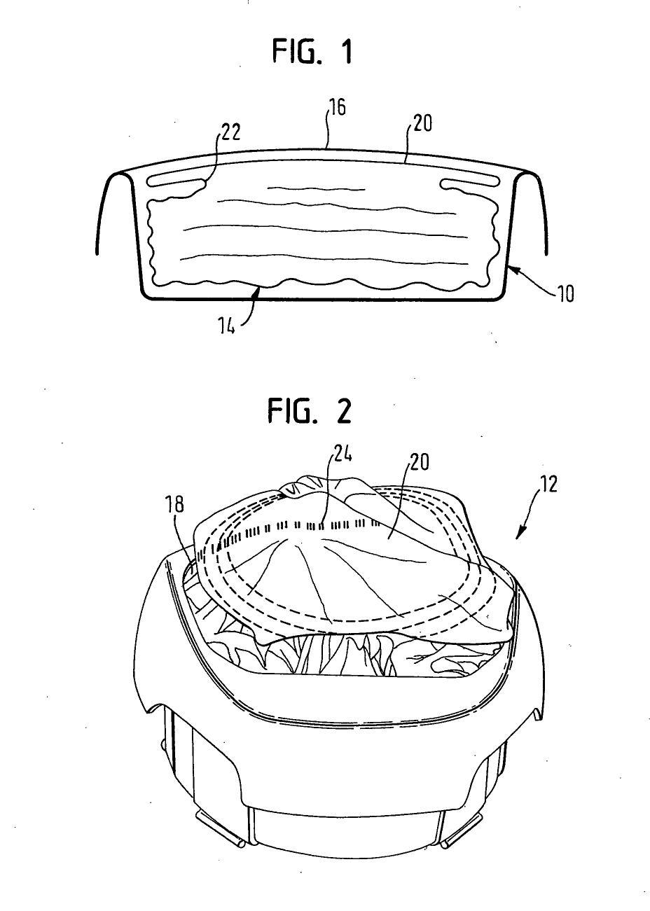

In FIG. 1, the mounting 10 of the driver's gas bag module 12 shown in FIG. 2 with a folded gas bag 14 is illustrated diagrammatically. The mounting 10 is substantially cup-shaped and closed on the side facing the driver by a cover 16. The cover 16 defines in a known manner an exposable outlet opening 18, out of which the folded gas bag 14 unfolds when the module 12 is activated.

The gas bag 14 has a substantially disordered folding, with the exception of a section 20 which lies directly opposite the cover 16. This section 20 is not folded and is delimited from the rest of the gas bag 14 by a constriction 22, so that a mushroom-like shape is produced. The constriction 22 arose during the preceding folding of the gas bag 14 (without measurements in the gas bag itself, such as additional seams or suchlike, for instance), and is no longer present in the unfolded state of the gas bag 14.

The non-folded section 20 of the gas bag 14 is a section which faces the driver in the unfolded state of the gas bag 14. The dimension of the non-folded section 20 corresponds approximately to that of the outlet opening 18. The gas bag 14 has several tethers (not shown) lying on the inside, each fastened with one end on the non-folded section 20. As can be seen in FIG. 2, a marking 24 is arranged on the non-folded section 20 which is readily and fully visible when the gas bag module 12 is not closed.

The radial and axial inflation behaviour of the gas bag 14 may be influenced, inter alia, by a rotation of the non-folded section 20 (clockwise or anti-clockwise) with respect to the rest of the gas bag 14. In this case, the constriction 22 is formed substantially by rotation of the non-folded section 20.

The pressure which the gas bag 14 exerts on the cover 16 on unfolding can be influenced by the axial height of the constriction 22. In addition, the visual appearance of the assembled module 12 can be improved by the size of the non-folded section 20, in particular with regard to the visibility of tear lines.

The invention is not restricted to a driver's module. The folding of the gas bag 14 according to the invention can also be used in passenger modules or other gas bag modules, in which a cover 16 is opened by the unfolding of the gas bag 14.

1. A gas bag module for a vehicle occupant restraint system, the gas bag module comprising a mounting which has an outlet opening closed by a cover, the gas bag module further comprising a gas bag accommodated in the mounting, which unfolds from a folded state out of the outlet opening when the gas bag module is activated, in the folded state the gas bag being folded in a mushroom-like manner, a non-folded section of the gas bag being delimited by a constriction and lying directly opposite the cover.

2. The gas bag module according to claim 1, wherein in the unfolded state of the gas bag, the non-folded section faceing the occupant.

3. The gas bag module according to claim 1, wherein the dimension of the non-folded section corresponds approximately to that of the outlet opening.

4. The gas bag module according to claim 1, wherein the gas bag has at least one tether which is fastened to the non-folded section.

5. The gas bag module according to claim 1, wherein the gas bag carries a marking which is arranged on the non-folded section.

6. The gas bag module according to claim 1, wherein the non-folded section is rotated with respect to the gas bag section lying on the other side of the constriction.
